(19) United States
(12) Patent Application Publication
(10) Pub. No.: US 2005/0175879 A1
(43) Pub. Date: Aug. 11, 2005

(54) Grafted polymer electrolyte membrane, method for the production thereof, and application thereof in fuel cells

(76) Inventors: Joachim Kiefer, Losheim am See (DE); Oemer Uensal, Mainz (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/513,949

(22) PCT Filed: May 12, 2003
(86) PCT No.: PCT/EP03/04913

(30) Foreign Application Priority Data
May 10, 2002 (DE) 10220817.4

(51) Int. Cl. H01M 8/10; C08J 5/22

(52) U.S. Cl. 429/33; 521/27

(57) ABSTRACT

The present invention relates to a proton-conducting polymer electrolyte membrane based on polyvinylphosphonic acid/polyvinylsulfonic acid polymers, which owing to their excellent chemical and thermal properties, can be used for a variety of purposes and is particularly suitable as polymer electrolyte membrane (PEM) in PEM fuel cells.

The present invention relates to a proton-conducting polymer electrolyte membrane based on organic polymers which have been pretreated by means of a radiation treatment and then grafted with vinylphosphonic acid and/or vinylsulfonic acid and, owing to their excellent chemical and thermal properties, can be used for a variety of purposes, in particular as polymer electrolyte membrane (PEM) in PEM fuel cells.

A fuel cell usually comprises an electrolyte and two electrodes separated by the electrolyte. In the case of a fuel cell, a fuel such as hydrogen gas or a methanol/water mixture is supplied to one of the two electrodes and an oxidant such as oxygen gas or air is supplied to the other electrode and chemical energy from the oxidation of the fuel is in this way converted directly into electric energy. The oxidation reaction forms protons and electrons.

The electrolyte is permeable to hydrogen ions, i.e. protons, but not to reactive fuels such as the hydrogen gas or methanol and the oxygen gas.

A fuel cell generally comprises a plurality of single cells known as MEUs (membrane-electrode unit) which each comprise an electrolyte and two electrodes separated by the electrolytes.

Electrolytes employed for the fuel cell are solids such as polymer electrolyte membranes or liquids such as phosphoric acid. Recently, polymer electrolyte membranes have attracted attention as electrolytes for fuel cells. In principle, a distinction can be made between two categories of polymer membranes.

The first category encompasses cation-exchange membranes comprising a polymer framework containing covalently bound acid groups, preferably sulfonic acid groups. The sulfonic acid group is converted into an anion with release of a hydrogen ion and therefore conducts protons. The mobility of the proton and thus the proton conductivity is linked directly to the water content. Due to the very good miscibility of methanol and water, such cation-exchange membranes have a high methanol permeability and are therefore unsuitable for use in a direct methanol fuel cell. If the membrane dries, e.g. as a result of a high temperature, the conductivity of the membrane and consequently the power of the fuel cell decreases drastically. The operating temperatures of fuel cells containing such cation-exchange membranes are thus limited to the boiling point of water. Moistening of the membranes represents a great technical challenge for the use of polymer electrolyte membrane fuel cells (PEMFCs) in which conventional, sulfonated membranes such as Nafion are used.

Materials used for polymer electrolyte membranes are, for example, perfluorosulfonic acid polymers. The perfluorosulfonic acid polymer (e.g. Nafion) generally has a perfluorinated hydrocarbon skeleton such as a copolymer of tetrafluoroethylene and trifluorovinyl and a side chain bearing a sulfonic acid group, e.g. a side chain bearing a sulfonic acid group bound to a perfluoroalkylene group, bound thereto.

The cation-exchange membranes are preferably organic polymers having covalently bound acid groups, in particular sulfonic acid. Processes for the sulfonation of polymers are described in F. Kucera et al. Polymer Engineering and Science 1988, Vol. 38, No. 5, 783-792.

The most important types of cation-exchange membranes which have achieved commercial importance for use in fuel cells are listed below.

The most important representative is the perfluorosulfonic acid polymer Nafion® (U.S. Pat. No. 3,692,569) from DuPont. This polymer can, as described in U.S. Pat. No. 4,453,991, be brought into solution and then used as ionomer.

Cation-exchange membranes are also obtained by filling a porous support material with such an ionomer. As support material, preference is given to expanded Teflon (U.S. Pat. No. 5,635,041).

Methods of synthesizing membranes from similar perfluorinated polymers containing sulfonic acid groups have also been developed by Dow Chemical, Asahi Glass or 3M Innovative Properties (U.S. Pat. No. 6,268,532, WO 2001/44314, WO 2001/094437).

A further perfluorinated cation-exchange membrane can be produced as described in U.S. Pat. No. 5,422,411 by copolymerization of trifluorostyrene and sulfonyl-modified trifluorostyrene. Composite membranes comprising a porous support material, in particular expanded Teflon, filled with ionomers consisting of such sulfonyl-modified trifluorostyrene copolymers are described in U.S. Pat. No. 5,834,523.

U.S. Pat. No. 6,110,616 describes copolymers of butadiene and styrene and their subsequent sulfonation to produce cation-exchange membranes for fuel cells.

Apart from the above membranes, a further class of nonfluorinated membranes produced by sulfonation of high-temperature-stable thermoplastics has been developed. Thus, membranes composed of sulfonated polyether ketones (DE-A-4219077, WO-96/01177), sulfonated polysulfone (J. Membr. Sci. 83 (1993) p. 211) or sulfonated polyphenylene sulfide (DE-A-19527435) are known.

Ionomers prepared from sulfonated polyether ketones are described in WO 00/15691.

Furthermore, acid-base blend membranes which are produced as described in DE-A-19817374 or WO 01/18894 by mixing sulfonated polymers and basic polymers are known.

To improve the membrane properties further, a cation-exchange membrane known from the prior art can be mixed with a high-temperature-stable polymer. The production and properties of cation-exchange membranes comprising blends of sulfonated polyether ketones and a) polysulfones (DE-A-4422158), b) aromatic polyamides (DE-A42445264) or c) polybenzimidazole (DE-A-19851498) are known.

Such membranes can also be obtained by processes in which polymers are grafted. For this purpose, a previously irradiated polymer film comprising a fluorinated or partially fluorinated polymer can, as described in EP-A-667983 or DE-A-19844645, be subject to a grafting reaction, preferably with styrene. As an alternative, fluorinated aromatic monomers such as trifluorostyrene can be used as graft component (WO 2001/58576). In a subsequent sulfonation reaction, the side chains are then sulfonated. Chlorosulfonic acid or oleum is used as sulfonating agent. In JP 2001/302721, a styrene-grafted film is reacted with 2-ketopentafluoropropanesulfonic acid and a membrane having a proton conductivity of 0.32 S/cm in the moistened state is thus obtained. A crosslinking reaction can also be carried out simultaneously with the grafting reaction and the mechanical properties and the fuel permeability can be altered in this way. As crosslinkers, it is possible to use, for example, divinylbenzene and/or triallyl cyanurate as described in EP-A-667983 or 1,4-butanediol diacrylate as described in JP2001/216837.

The processes for producing such radiation-grafted and sulfonated membranes are very complex and comprise numerous process steps such as i) preparation of the polymer film; ii) irradiation of the polymer film, preferably under inert gas, and storage at low temperatures (<60° C.); iii) grafting reaction under nitrogen in a solution of suitable monomers and solvents; iv) extraction of the solvent; v) drying of the grafted film; vi) sulfonation reaction in the presence of aggressive reagents and chlorinated hydrocarbons, e.g. chlorosulfonic acid in tetrachloroethane; vii) repeated washing to remove excess solvents and sulfonation reagents; viii) reaction with dilute alkalis such as aqueous potassium hydroxide solution for conversion into the salt form; ix) repeated washing to remove excess alkali; x) reaction with dilute acid such as hydrochloric acid; xi) final repeated washing to remove excess acid.

A disadvantage of all these cation-exchange membranes is the fact that the membrane has to be moistened, the operating temperature is limited to 100° C. and the membranes have a high methanol permeability. The reason for these disadvantages is the conductivity mechanism of the membrane, with the transport of the protons being coupled to the transport of the water molecule. This is referred to as the “vehicle mechanism” (K.-D. Kreuer, Chem. Mater. 1996, 8, 610-641).

One possible way of increasing the operating temperature is to operate the fuel cell system under superatmospheric pressure in order to increase the boiling point of water. However, it has been found that this method is associated with many disadvantages, since the fuel cell system becomes more complicated, the efficiency decreases and there is an increase in weight instead of the desired weight decrease. Furthermore, an increase in the pressure leads to higher mechanical stresses on the thin polymer membrane and can lead to failure of the membrane and thus cessation of operation of the system.

A second category which has been developed encompasses polymer electrolyte membranes comprising complexes of basic polymers and strong acids, which can be operated without moistening. Thus, WO 96/13872 and the corresponding U.S. Pat. No. 5,525,436 describe a process for producing a proton-conducting polymer electrolyte membrane, in which a basic polymer such as polybenzimidazole is treated with a strong acid such as phosphoric acid, sulfuric acid, etc.

J. Electrochem. Soc., volume 142, No. 7, 1995, pp. L121-L123, describes doping of a polybenzimidazole in phosphoric acid.

In the case of the basic polymer membranes known from the prior art, the mineral acid (usually concentrated phosphoric acid) used for achieving the necessary proton conductivity is either introduced after shaping or, as an alternative, the basic polymer membrane is produced directly from polyphosphoric acid, as described in the German patent applications No. 10117686.4, No. 10144815.5 and No. 10117687.2. The polymer here serves as support for the electrolytes consisting of the highly concentrated phosphoric acid or polyphosphoric acid. The polymer membrane in this case fulfils further important functions, in particular it has to have a high mechanical stability and serve as separator for the two fuels mentioned at the outset.

One possible way of producing a radiation-grafted membrane for operation at temperatures above 100° C. is described in JP 2001-213987 (Toyota). For this purpose, a partially fluorinated polymer film of polyethyene-tetrafluoroethylene or polyvinyl difluoride is irradiated and subsequently reacted with a basic monomer such as vinylpyridine. As a result of the incorporation of grafted side chains of polyvinylpyridine, these radiation-grafted materials display high swelling with phosphoric acid. Proton-conducting membranes having a conductivity of 0.1 S/cm at 180° C. without moistening are produced by doping with phosphoric acid.

JP2000/331693 describes the production of an anion-exchange membrane by radiation grafting. Here, the grafting reaction is carried out using a vinylbenzyl-trimethylammonium salt or quaternary salts of vinylpyridine or vinylimidazole. However, such anion-exchange membranes are not suitable for use in fuel cells.

Significant advantages of such a membrane doped with phosphoric acid or polyphosphoric acid is the fact that a fuel cell in which such a polymer electrolyte membrane is used can be operated at temperatures above 100° C. without the moistening of the fuel cell which is otherwise necessary. This is due to the ability of the phosphoric acid to transport protons without additional water by means of the Grotthus mechanism (K.-D. Kreuer, Chem. Mater. 1996, 8, 610-641).

The possibility of operation at temperatures above 100° C. results in further advantages for the fuel cell system. Firstly, the sensitivity of the Pt catalyst to impurities in the gas, in particular CO, is greatly reduced. CO is formed as by-product in the reforming of the hydrogen-rich gas comprising carbon-containing compounds, e.g. natural gas, methanol or petroleum spirit, or as intermediate in the direct oxidation of methanol. The CO content of the fuel typically has to be less than 100 ppm at temperatures of <100° C. However, at temperatures in the range 150-200° C., 10 000 ppm or more of CO can also be tolerated (N. J. Bjerrum et al. Journal of Applied Electrochemistry, 2001, 31,773-779). This leads to significant simplifications of the upstream reforming process and thus to cost reductions for the total fuel cell system.

A great advantage of fuel cells is the fact that the electrochemical reaction converts the energy of the fuel directly into electric energy and heat. Water is formed as reaction product at the cathode. Heat is thus generated as by-product in the electrochemical reaction. In the case of applications in which only the electric power is utilized for driving electric motors, e.g. in automobile applications, or as replacement for battery systems in many applications, the heat has to be removed in order to avoid overheating of the system. Additional, energy-consuming equipment is then necessary for cooling, and this further reduces the total electrical efficiency of the fuel cell. In the case of stationary applications such as central or decentralized generation of power and heat, the heat can be utilized efficiently by means of existing technologies, e.g. heat exchangers. High temperatures are sought here to increase the efficiency. If the operating temperature is above 100° C. and the temperature difference between ambient temperature and the operating temperature is large, it is possible to cool the fuel cell system more efficiently or employ small cooling areas and dispense with additional equipment compared to fuel cells which have to be operated at below 100° C. because of the moistening of the membrane.

Besides these advantages, such a fuel cell system has a critical disadvantage. Phosphoric acid or polyphosphoric acid is present as an electrolyte which is not permanently bound to the basic polymer by ionic interactions and can be washed out by means of water. As described above, water is formed at the cathode in the electrochemical reaction. If the operating temperature is above 100° C., the water is mostly discharged as vapor through the gas diffusion electrode and the loss of acid is very small. However, if the operating temperature is below 100° C., e.g. during start-up and shutdown of the cell or in part load operation when a high current yield is sought, the water formed condenses and can lead to increased washing out of the electrolyte, viz. the highly concentrated phosphoric acid or polyphosphoric acid. This can, during such operation of the fuel cell, lead to a continual decrease in the conductivity and the cell power, which can reduce the life of the fuel cell.

Furthermore, the known membranes doped with phosphoric acid cannot be used in the direct methanol fuel cell (DMFC). However, such cells are of particular interest, since a methanol/water mixture is used as fuel. If a known membrane based on phosphoric acid is used, the fuel cell fails after quite a short time.

It is therefore an object of the present invention to provide a novel polymer electrolyte membrane in which washing out of the electrolyte is prevented. In particular, the operating temperature should be able to be extended to the range from <° C. to 200° C. in this way. A fuel cell comprising a polymer electrolyte membrane according to the invention should be suitable for operation using pure hydrogen or numerous carbon-containing fuels, in particular natural gas, petroleum spirit, methanol and biomass.

Furthermore, a membrane according to the invention should be able to be produced inexpensively and simply. In addition, it was consequently an object of the present invention to create polymer electrolyte membranes which display good performance, in particular a high conductivity.

Furthermore, it was an object to create a polymer electrolyte membrane which has a high mechanical stability, in particular a high modulus of elasticity, a high tear strength, low creep and a high fracture toughness.

Furthermore, it was consequently an object of the present invention to provide a membrane which has a low permeability to a wide variety of fuels, for example hydrogen or methanol, during operation. This membrane should also display a low oxygen permeability.

A further object of the present invention is to simplify and reduce the number of process steps in the production of a membrane according to the invention by means of radiation grafting, so that the steps can also be carried out on an industrial scale.

This object is achieved by modification of a powder based on industrial polymers by means of radiation and subsequent treatment with monomers containing vinyl-phosphonic acid and/or vinylsulfonic acid and subsequent polymerization of these and shaping, leading to a grafted polymer electrolyte membrane or an ionomer, with the polyvinylphosphonic acid/polyvinylsulfonic acid polymer being covalently bound to the polymer backbone.

Due to the concentration of polyvinylphoshonic acid/polyvinylsulfonic acid polymer, its high chain flexibility and the high acid strength of polyvinylphosphonic acid, the conductivity is based on the Grotthus mechanism and the system thus requires no additional moistening at temperatures above the boiling point of water. Conversely, satisfactory conductivity of the system is observed at temperatures below the boiling point of water when the system is appropriately moistened due to the presence of the polyvinylsulfonic acid.

The polymeric polyvinylphosphonic/polyvinylsulfonic acid, which can also be crosslinked by means of reactive groups, is covalently bound to the polymer chain as a result of the grafting reaction and is not washed out by product water formed or, in the case of a DMFC, by the aqueous fuel. A polymer electrolyte membrane according to the invention has a very low methanol permeability and is particularly suitable for use in a DMFC. Long-term operation of a fuel cell using many fuels such as hydrogen, natural gas, petroleum spirit, methanol or biomass is thus possible. Here, the membranes make a particularly high activity of these fuels possible. Due to the high temperatures, the oxidation of methanol can occur with high activity. In a particular embodiment, these membranes are suitable for operation in a gaseous DMFC, in particular at temperatures in the range from 100 to 200° C.

The possibility of operation at temperatures above 100° C. results in a big decrease in the sensitivity of the Pt catalyst to impurities in the gas, in particular CO. CO is formed as by-product in the reforming of the hydrogen-rich gas comprising carbon-containing compounds, e.g. natural gas, methanol or petroleum spirit, or as intermediate in the direct oxidation of methanol. The CO content of the fuel can typically be greater than 5000 ppm at temperatures above 120° C. without the catalytic action of the Pt catalyst being drastically reduced. However, at temperatures in the range 150-200° C., 10 000 ppm or more of CO can also be tolerated (N. J. Bjerrum et al. Journal of Applied Electrochemistry, 2001, 31, 773-779). This leads to significant simplifications of the upstream reforming process and thus to cost reductions for the total fuel cell system.

A membrane according to the invention displays a high conductivity, which is also achieved without additional moistening, over a wide temperature range. Furthermore, a fuel cell equipped with a membrane according to the invention can also be operated at low temperatures, for example at 80° C. or less, without the life of the fuel cell being very greatly reduced thereby.

The present invention provides a proton-conducting electrolyte membrane obtainable by a process comprising the steps:
A. irradiation of a polymer with radiation to generate free radicals,
B. preparation of a mixture of the polymer which has been irradiated in step A) with vinyl-containing phosphonic acid monomers and/or vinyl-containing sulfonic acid monomers,
C. polymerization of the vinyl-containing phosphonic acid and/or vinyl-containing sulfonic acid monomers introduced in step B),
D. casting of a sheet-like structure comprising polymers which have been obtained according to step C),
E. drying of the sheet-like structure to form a self-supporting membrane.

The polymers used in step A) are preferably one or more polymers which have a solubility of at least 1% by weight, preferably at least 3% by weight, in the phosphonic acid and/or vinyl-containing sulfonic acid monomers, with the solubility being dependent on the temperature. However, the mixture used for forming the sheet-like structure can also be obtained within a wide temperature range, so that only the required minimum solubility has to be achieved. The lower limit to the temperature is given by the melting point of the liquid present in the mixture, with the upper temperature limit generally being imposed by the decomposition temperatures of the polymers or the constituents of the mixture. In general, the mixture is prepared in a temperature range from 0° C. to 250° C., preferably from 10° C. to 200° C. Furthermore, superatmospheric pressure can be used for the dissolution, with the limits being imposed by technical considerations. Particular preference is given to using a polymer which has a solubility of at least 1% by weight in the phosphonic acid and/or vinyl-containing sulfonic acid monomers at 160° C. and 1 bar in step A).

Preferred polymers include, inter alia, polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyvinyl difluoride, polyhexafluoropropylene, polyethylene-tetrafluoroethylene, copolymers of PTFE with hexafluoropropylene, with perfluoropropyl vinyl ether, with trifluoronitroisomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular ones derived from norbornene;
polymers having C—O bonds in the main chain, for example polyacetal, polyoxymethylene, polyethers, polypropylene oxide, polyepichlorohydrin, polytetrahydrofuran, polyphenylene oxide, polyether ketone, polyether ether ketone, polyether ketone ketone, polyether ether ketone ketone, polyether ketone ether ketone ketone, polyesters, in particular polyhydroxyacetic acid, polyethylene terephthalate, polybutylene terephthalate, polyhydroxybenzoate, polyhydroxypropionic acid, polypropionic acid, polypivalolactone, polycaprolactone, furan resins, phenol-aryl resins, polymalonic acid, polycarbonate;
polymers having C—S bonds in the main chain, for example polysulfide ether, polyphenylene sulfide, polyether sulfone, polysulfone, polyether ether sulfone, polyaryl ether sulfone, polyphenylene sulfone, polyphenylene sulfide sulfone, poly(phenyl sulfide-1,4-phenylene);
polymers having C—N bonds in the main chain, for example polyimines, polyisocyanides, polyetherimine, polyetherimides, poly(trifluoromethylbis(phthalimido)phenyl), polyaniline, polyaramides, polyamides, polyhydrazides, polyurethanes, polyimides, polyazoles, polyazole ether ketone, polyureas, polyazines;
liquid-crystalline polymers, in particular Vectra, and
inorganic polymers, for example polysilanes, polycarbosilanes, polysiloxanes, polysilicic acid, polysilicates, silicones, polyphosphazines and polythiazyl.

According to a particular aspect of the present invention, preference is given to using polymers containing at least one fluorine, nitrogen, oxygen and/or sulfur atom in one repeating unit or in different repeating units.

In a particular embodiment, preference is given to using high-temperature-stable polymers. For the purposes of the present invention, a polymer is high-temperature-stable when it can be used in long-term operation as polymer electrolyte in a fuel cell at temperatures above 120° C. “Long-term” means that a membrane according to the invention can be operated for at least 100 hours, preferably at least 500 hours, at at least 120° C., preferably at least 160° C., without the power, which can be measured by the method described in WO 01/18894 A2, decreasing by more than 50%, based on the initial power.

The polymers used in step A) are preferably polymers which have a glass transition temperature or Vicat softening temperature VST/A/50 of at least 100° C., preferably at least 150° C. and very particularly preferably at least 180° C.

Particular preference is given to polymers which have at least one nitrogen atom in a repeating unit. Very particular preference is given to polymers which have at least one aromatic ring containing at least one nitrogen heteroatom per repeating unit. Within this group, polymers based on polyazoles are particularly preferred. These basic polyazole polymers have at least one aromatic ring containing at least one nitrogen heteroatom per repeating unit.

The aromatic ring is preferably a five- or six-membered ring which contains from one to three nitrogen atoms and may be fused with another ring, in particular another aromatic ring.

Polymers based on polyazole comprise recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVI) and/or (XVII) and/or (XVIII) and/or (XIX) and/or (XX) and/or (XXI) and/or (XXII) 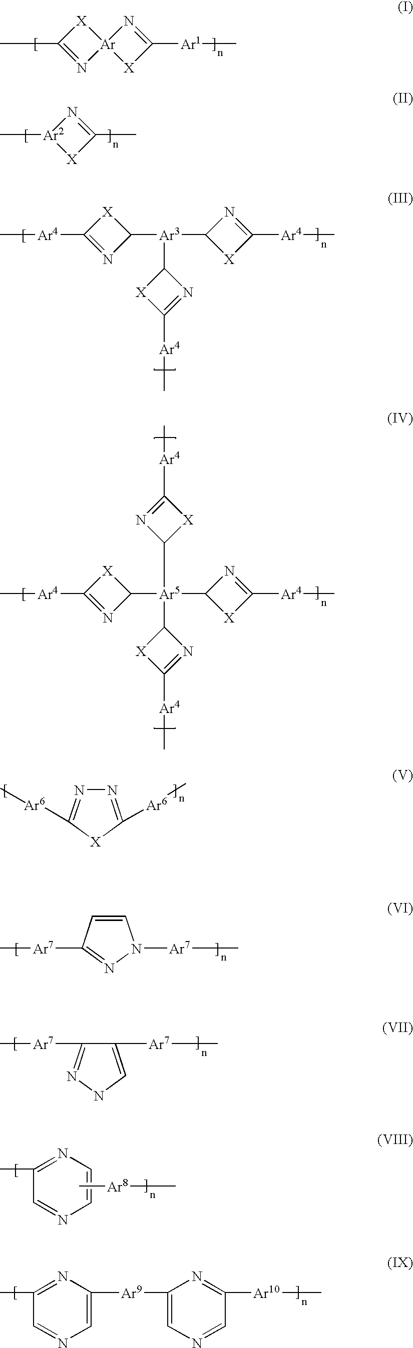 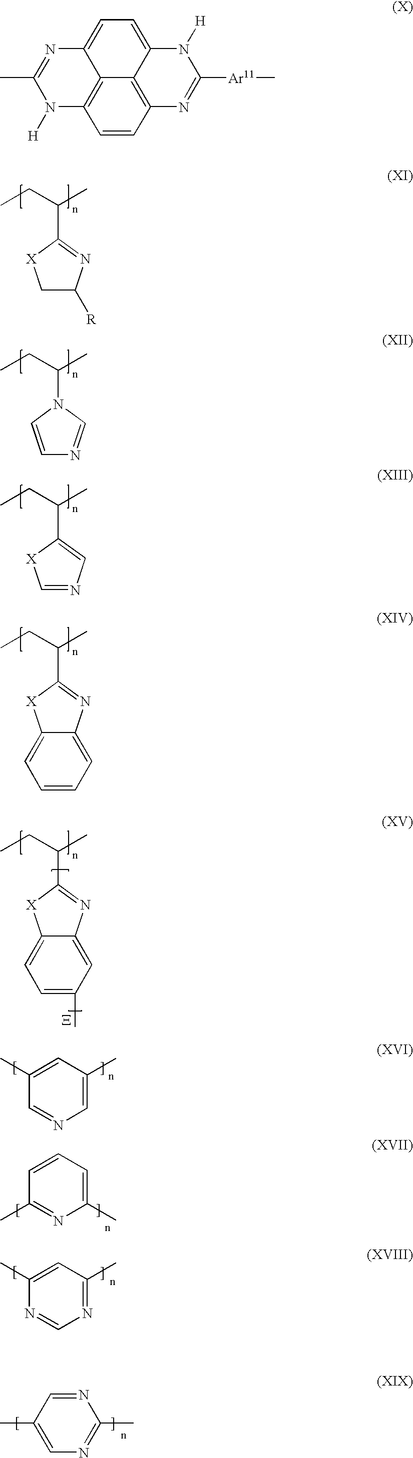 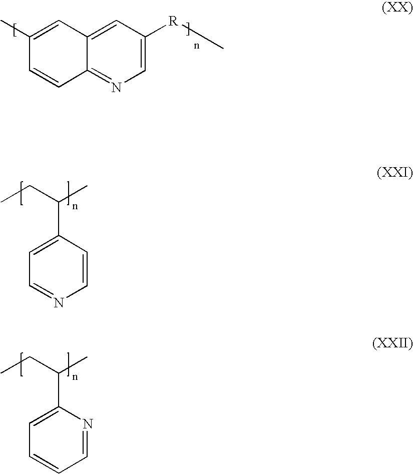
where
the radicals Ar are identical or different and are each a tetravalent aromatic or heteroaromatic group which can be monocyclic or polycyclic,
the radicals Ar¹ are identical or different and are each a divalent aromatic or heteroaromatic group which can be monocyclic or polycyclic,
the radicals Ar² are identical or different and are each a divalent or trivalent aromatic or heteroaromatic group which can be monocyclic or polycyclic,
the radicals Ar³ are identical or different and are each a trivalent aromatic or heteroaromatic group which can be monocyclic or polycyclic,
the radicals Ar⁴ are identical or different and are each a trivalent aromatic or heteroaromatic group which can be monocyclic or polycyclic,
the radicals Ar⁵ are identical or different and are each a tetravalent aromatic or heteroaromatic group which can be monocyclic or polycyclic,
the radicals Ar⁶ are identical or different and are each a divalent aromatic or heteroaromatic group which can be monocyclic or polycyclic,
the radicals Ar⁷ are identical or different and are each a divalent aromatic or heteroaromatic group which can be monocyclic or polycyclic,
the radicals Ar⁸ are identical or different and are each a trivalent aromatic or heteroaromatic group which can be monocyclic or polycyclic,
the radicals Ar⁹ are identical or different and are each a divalent or trivalent or tetravalent aromatic or heteroaromatic group which can be monocyclic or polycyclic,
the radicals Ar¹⁰ are identical or different and are each a divalent or trivalent aromatic or heteroaromatic group which can be monocyclic or polycyclic,
the radicals Ar¹¹ are identical or different and are each a divalent aromatic or heteroaromatic group which can be monocyclic or polycyclic,
the radicals X are identical or different and are each oxygen, sulfur or an amino group which bears a hydrogen atom, a group having 1-20 carbon atoms, preferably a branched or unbranched alkyl or alkoxy group, or an aryl group as further radical,
the radicals R are identical or different and are each hydrogen, an alkyl group or an aromatic group and
n, m are each an integer greater than or equal to 10, preferably greater than or equal to 100.

Aromatic or heteroaromatic groups which are preferred according to the invention are derived from benzene, naphthalene, biphenyl, diphenyl ether, diphenylmethane, diphenyldimethylmethane, bisphenone, diphenyl sulfone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may also be substituted.

Ar¹, Ar⁴, Ar⁶, Ar⁷, Ar⁸, Ar⁹, Ar¹⁰, Ar¹¹ can have any substitution pattern; in the case of phenylene, Ar¹, Ar⁴, Ar⁶, Ar⁷, Ar⁸, Ar⁹, Ar¹⁰, Ar¹¹ can be, for example, ortho-, meta- or para-phenylene. Particularly preferred groups are derived from benzene and biphenylene, which may also be substituted.

Preferred alkyl groups are short-chain alkyl groups having from 1 to 4 carbon atoms, e.g. methyl, ethyl, n- or i-propyl and t-butyl groups.

Preferred aromatic groups are phenyl and naphthyl groups. The alkyl groups and the aromatic groups may be substituted.

Preferred substituents are halogen atoms such as fluorine, amino groups, hydroxy groups or short-chain alkyl groups such as methyl or ethyl groups.

Preference is given to polyazoles having recurring units of the formula (I) in which the radicals X within one recurring unit are identical.

The polyazoles can in principle also have different recurring units which differ, for example, in their radical X. However, preference is given to only identical radicals X being present in a recurring unit.

In a further embodiment of the present invention, the polymer comprising recurring azole units is a copolymer or a blend comprising at least two units of the formulae (I) to (XXII) which differ from one another. The polymers can be in the form of block copolymers (diblock, triblock), random copolymers, periodic copolymers and/or alternating polymers.

The number of recurring azole units in the polymer is preferably greater than or equal to 10. Particularly preferred polymers contain at least 100 recurring azole units.

For the purposes of the present invention, polymers comprising recurring benzimidazole units are preferred. Some examples of extremely advantageous polymers comprising recurring benzimidazole units are represented by the following formulae: 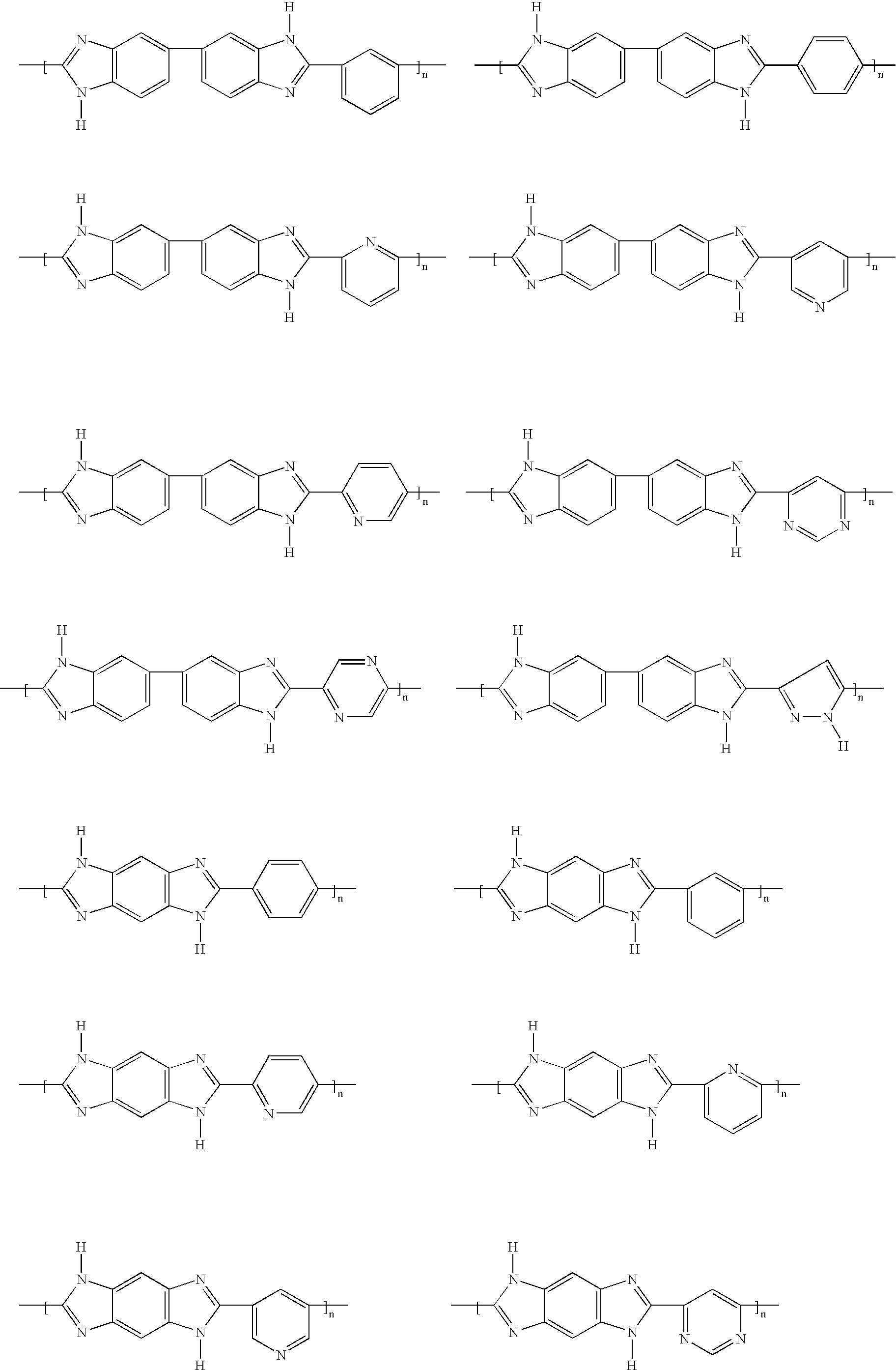 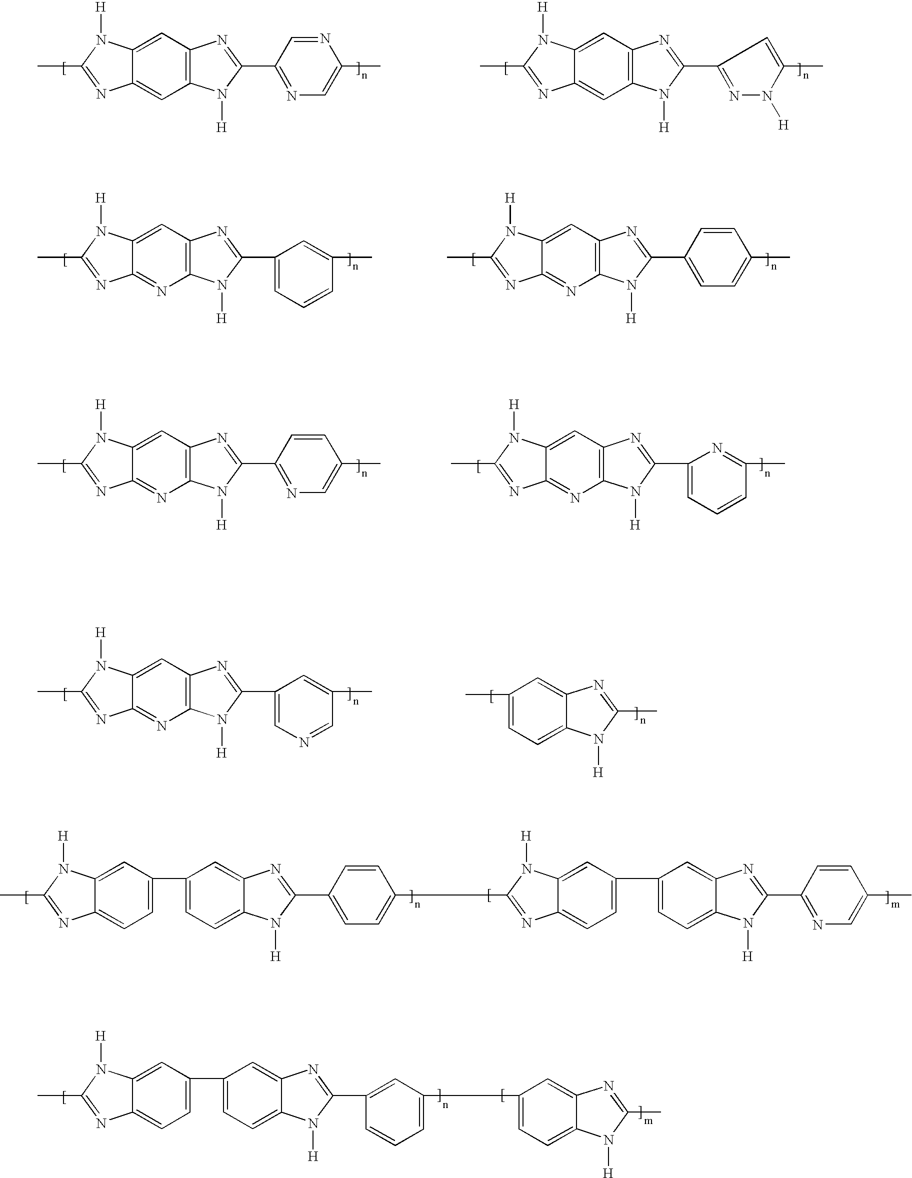 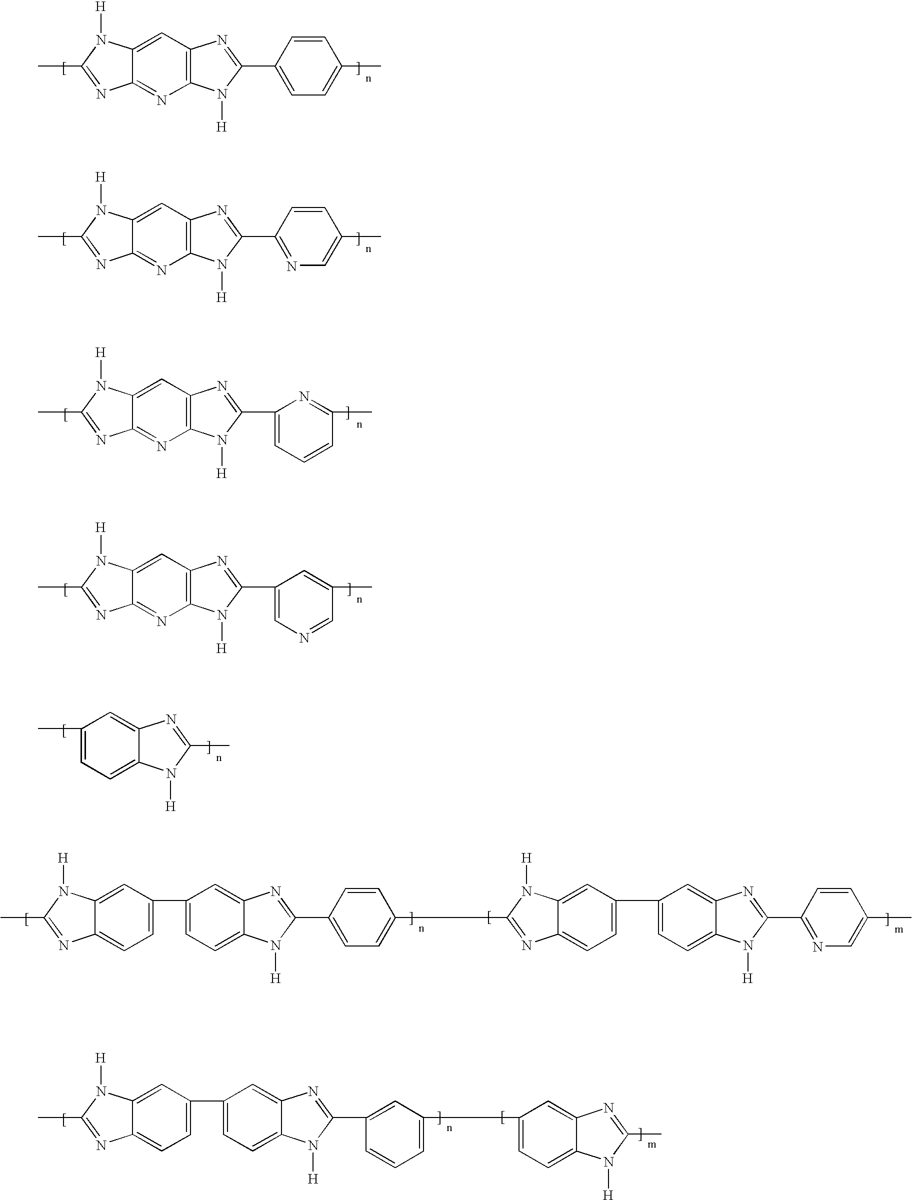
where n and m are each an integer greater than or equal to 10, preferably greater than or equal to 100.

Further preferred polyazole polymers are polyimidazoles, polybenzimidazole ether ketone, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Particular preference is given to Celazole from Celanese, in particular one in which the polymer worked up by sieving as described in the German patent application No. 10129458.1 is used.

The polyazoles used, but in particular the polybenzimidazoles, have a high molecular weight. Measured as intrinsic viscosity, it is at least 0.2 dl/g, preferably from 0.8 to 10 dl/g, in particular from 1 to 10 dl/g.

Preference is also given to polyazoles which have been obtained by the methods described in the German patent application No. 10117687.2.

Preferred polymers include polysulfones, in particular polysulfones having aromatic and/or heteroaromatic groups in the main chain. According to a particular aspect of the present invention, preferred polysulfones and polyether sulfones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. Polysulfones having a Vicat softening temperature VST/A/50 of from 180 to 230° C. are preferred here. In another preferred embodiment of the present invention, the number average molecular weight of the polysulfones is greater than 30 000 g/mol.

Polymers based on polysulfone include, in particular, polymers which comprise recurring units having linked sulfone groups and corresponding to the general formulae A, B, C, D, E, F and/or G: 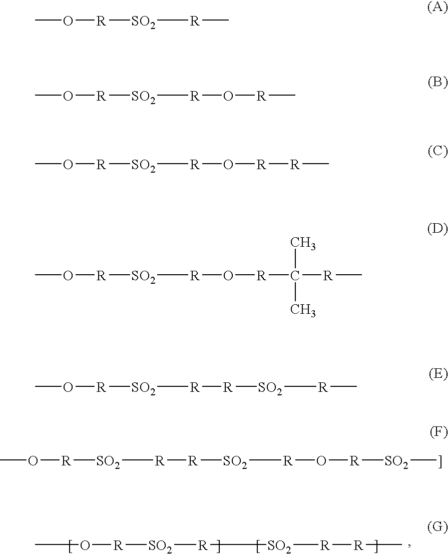
where the radicals R are identical or different and are each, independently of one another, an aromatic or heteroaromatic group, with these radicals having been described in more detail above. They include, in particular, 1,2-phenylene, 1,3-phenylene, 1,4-phenylene, 4,4′-biphenyl, pyridine, quinoline, naphthalene, phenanthrene.

Polysulfones which are preferred for the purposes of the present invention encompass homopolymers and copolymers, for example random copolymers. Particularly preferred polysulfones comprise recurring units of the formulae H to N:

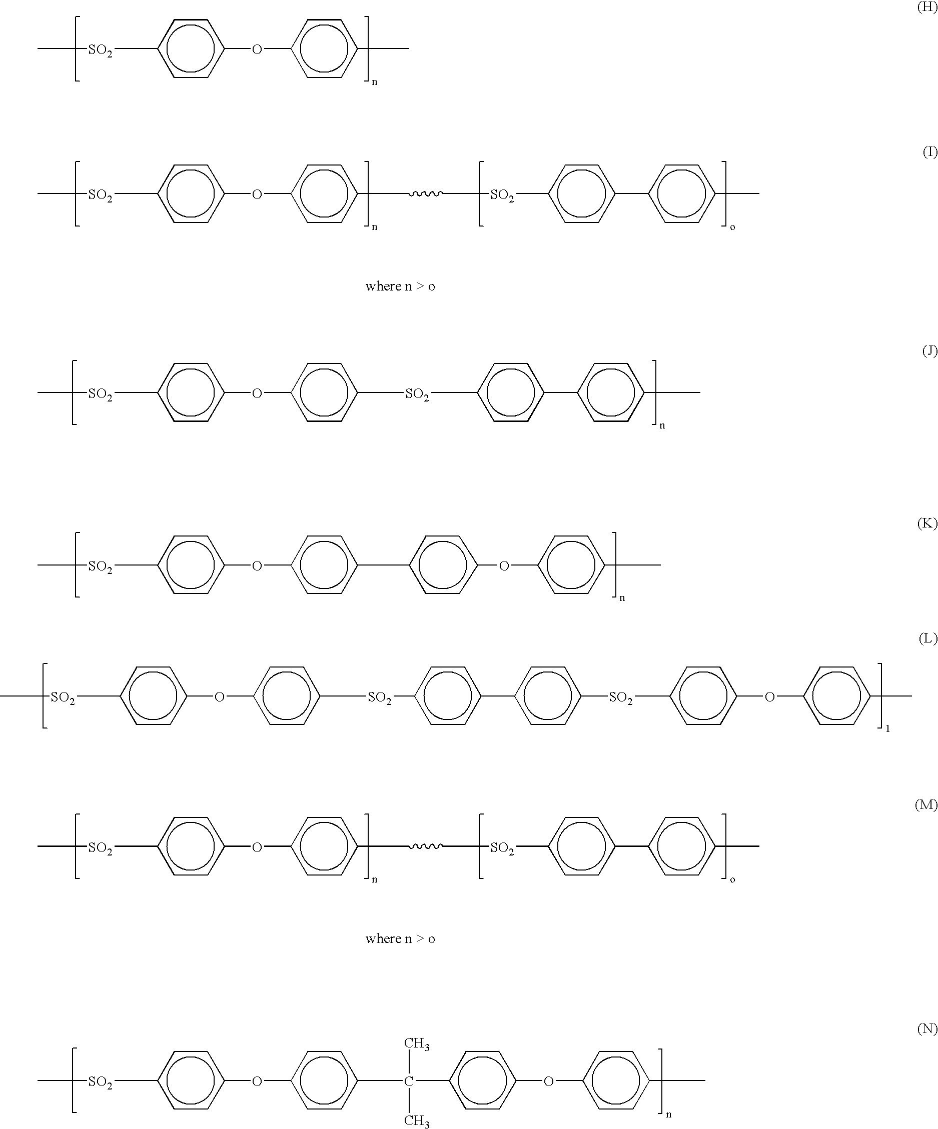

The above-described polysulfones are commercially available under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

In addition, polyether ketones, polyether ketone ketones, polyether ether ketones, polyether ether ketone ketones and polyaryl ketones are particularly preferred. These high-performance polymers are known per se and are commercially available under the trade names Victrex® PEEK™, ®Hostatec, ®Kadel.

The abovementioned polymers can be used individually or as a mixture (blend). Particular preference is given to blends comprising polyazoles and/or polysulfones. The use of blends enables the mechanical properties to be improved and the materials costs to be reduced.

To generate the free radicals, the polymer is treated one or more times with a single radiation or various types of radiation in step A) until a sufficient concentration of free radicals has been obtained. Types of radiation used are, for example, electromagnetic radiation, in particular γ-radiation, and/or electron beams, for example β-radiation. A sufficiently high concentration of free radicals is achieved at a radiation dose of from 1 to 500 kGy, preferably from 3 to 300 kGy and very particularly preferably from 5 to 200 kGy. Particular preference is given to irradiation with electrons. Irradiation can be carried out in air or inert gas.

After irradiation, the samples can be stored at temperatures below −50° C. for a period of weeks without the free radical activity decreasing appreciably.

It is possible to use solvents in steps B) and C). In this case, any organic or inorganic solvent can be used. Organic solvents include, in particular, polar aprotic solvents such as dimethyl sulfoxide (DMSO), esters such as ethyl acetate and polar protic solvents such as alcohols, e.g. ethanol, propanol, isopropanol and/or butanol. Strong bases such as KOH and/or NaOH can be added to the polar protic solvents, in particular the alcohols. Inorganic solvents include, in particular, water, phosphoric acid and polyphosphoric acid.

Preference is given to solvents which produce a homogeneous mixture of the polymers from step A) and the vinyl-containing acid monomers from step B). Preferred solvents are aprotic solvents such as dimethylacetamide, N-methylpyrrolidone, dimethylformamide or dimethyl sulfoxide (DMSO).

Vinyl-containing phosphonic acids are known to those skilled in the art. They are compounds which have at least one carbon-carbon double bond and at least one phosphonic acid group. The two carbon atoms which form the carbon-carbon double bond preferably have at least two, more preferably 3, bonds to groups which lead to low steric hindrance of the double bond. Such groups include, inter alia, hydrogen atoms and halogen atoms, in particular fluorine atoms. For the purposes of the present invention, the polyvinylphosphonic acid is the polymerization product obtained by polymerization of the vinyl-containing phosphonic acid either alone or with further monomers and/or crosslinkers.

The vinyl-containing phosphonic acid can have one, two, three or more carbon-carbon double bonds. Furthermore, the vinyl-containing phosphonic acid can contain 1, 2, 3 or more phosphonic acid groups.

In general, the vinyl-containing phosphonic acid contains from 2 to 20, preferably from 2 to 10, carbon atoms.

The vinyl-containing phosphonic acid used in step B) is preferably a compound of the formula 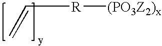
where
R is a bond, a C1-C15-alkyl group, C1-C15-alkoxy group, ethylenoxy group or C5-C20-aryl or heteroaryl group, with the above radicals themselves being able to be substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals themselves being able to be substituted by halogen, —OH, —CN, and
x is 1, 2, 3, 4, 5, 6, 7, 8, 9 or 10,
y is 1, 2, 3, 4, 5, 6, 7, 8, 9 or 10,
   and/or of the formula 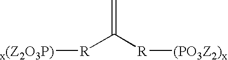
   where
R is a bond, a C1-C15-alkyl group, C1-C15-alkoxy group, ethylenoxy group or C5-C20-aryl or heteroaryl group, with the above radicals themselves being able to be substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals themselves being able to be substituted by halogen, —OH, —CN, and
x is 1, 2, 3, 4, 5, 6, 7, 8, 9 or 10,
   and/or of the formula 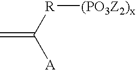
   where
A is a group of the formulae COOR², CN, CONR²₂, OR² and/or R², where R² is hydrogen, a C1-C15-alkyl group, C1-C15-alkoxy group, ethylenoxy group or C5-C20-aryl or heteroaryl group, with the above radicals themselves being able to be substituted by halogen, —OH, COOZ, —CN, NZ₂,
R is a bond, a divalent C1-C15-alkylene group, divalent C1-C15-alkoxy group, for example ethylenoxy group, or divalent C5-C20-aryl or heteroaryl group, with the above radicals themselves being able to be substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals themselves being able to be substituted by halogen, —OH, —CN, and
x is 1, 2, 3, 4, 5, 6, 7, 8, 9 or 10.

Preferred vinyl-containing phosphonic acids include, inter alia, alkenes containing phosphonic acid groups, e.g. ethenephosphonic acid, propenephosphonic acid, butenephosphonic acid; acrylic acid and/or methacrylic acid compounds containing phosphonic acid groups, for example 2-phosphonomethylacrylic acid, 2-phosphonomethylmethacrylic acid, 2-phosphonomethylacrylamide and 2-phosphonomethylmethacrylamide.

Particular preference is given to using commercial vinylphosphonic acid (ethenephosphonic acid) as is available, for example, from Aldrich or Clariant GmbH.

A preferred vinylphosphonic acid has a purity of more than 70%, in particular 90% and particularly preferably more than 97%.

Furthermore, the vinyl-containing phosphonic acids can also be used in the form of derivatives which can subsequently be converted into the acid, with the conversion into the acid also being able to be carried out in the polymerized state. Derivatives of this type include, in particular, the salts, esters, amides and halides of the vinyl-containing phosphonic acids.

Vinyl-containing sulfonic acids are known to those skilled in the art. They are compounds which have at least one carbon-carbon double bond and at least one sulfonic acid group. The two carbon atoms which form the carbon-carbon double bond preferably have at least two, more preferably 3, bonds to groups which lead to low steric hindrance of the double bond. Such groups include, inter alia, hydrogen atoms and halogen atoms, in particular fluorine atoms. For the purposes of the present invention, the polyvinylsulfonic acid is the polymerization product obtained by polymerization of the vinyl-containing sulfonic acid either alone or with further monomers and/or crosslinkers.

The vinyl-containing sulfonic acid can have one, two, three or more carbon-carbon double bonds. Furthermore, the vinyl-containing sulfonic acid can contain 1, 2, 3 or more sulfonic acid groups.

In general, the vinyl-containing sulfonic acid contains from 2 to 20, preferably from 2 to 10, carbon atoms.

The vinyl-containing sulfonic acid used in step B) is preferably a compound of the formula 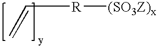
where
R is a bond, a C1-C15-alkyl group, C1-C15-alkoxy group, ethylenoxy group or C5-C20-aryl or heteroaryl group, with the above radicals themselves being able to be substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals themselves being able to be substituted by halogen, —OH, —CN, and
x is 1, 2, 3, 4, 5, 6, 7, 8, 9 or 10,
y is 1, 2, 3, 4, 5, 6, 7, 8, 9 or 10,
   and/or of the formula 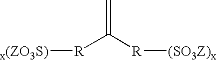
   where
R is a bond, a C1-C15-alkyl group, C1-C15-alkoxy group, ethylenoxy group or C5-C20-aryl or heteroaryl group, with the above radicals themselves being able to be substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals themselves being able to be substituted by halogen, —OH, —CN, and
x is 1, 2, 3, 4, 5, 6, 7, 8, 9 or 10,
   and/or of the formula 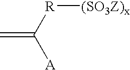
   where
A is a group of the formulae COOR², CN, CONR²₂, OR² and/or R², where R² is hydrogen, a C1-C15-alkyl group, C1-C15-alkoxy group, ethylenoxy group or C5-C20-aryl or heteroaryl group, with the above radicals themselves being able to be substituted by halogen, —OH, COOZ, —CN, NZ₂,
R is a bond, a divalent C1-C15-alkylene group, divalent C1-C15-alkoxy group, for example ethylenoxy group, or divalent C5-C20-aryl or heteroaryl group, with the above radicals themselves being able to be substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals themselves being able to be substituted by halogen, —OH, —CN, and
x is 1, 2, 3, 4, 5, 6, 7, 8, 9 or 10.

Preferred vinyl-containing sulfonic acids include, inter alia, alkenes containing sulfonic acid groups, e.g. ethenesulfonic acid, propenesulfonic acid, butenesulfonic acid; acrylic acid and/or methacrylic acid compounds containing sulfonic acid groups, for example 2-sulfomethylacrylic acid, 2-sulfomethylmethacrylic acid, 2-sulfomethylacrylamide and 2-sulfomethylmethacrylamide.

Particular preference is given to using commercial vinylsulfonic acid (ethenesulfonic acid) as is available, for example, from Aldrich or Clariant GmbH. A preferred vinylsulfonic acid has a purity of more than 70%, in particular 90% and particularly preferably more than 97%.

Furthermore, the vinyl-containing sulfonic acids can also be used in the form of derivatives which can subsequently be converted into the acid, with the conversion into the acid also being able to be carried out in the polymerized state. Derivatives of this type include, in particular, the salts, esters, amides and halides of the vinyl-containing sulfonic acids.

The mixture used in step B) and step C) comprises either vinyl-containing phosphonic acid monomers or vinyl-containing sulfonic acid monomers. Furthermore, the mixture can comprise both vinyl-containing sulfonic acid monomers and vinyl-containing phosphonic acid monomers. The mixing ratio of vinyl-containing sulfonic acid monomers to vinyl-containing phosphonic acid monomers is preferably in the range from 1:99 to 99:1, more preferably from 1:50 to 50:1, in particular from 1:25 to 25:1.

The content of vinylsulfonic acid monomers in compositions used for grafting is preferably at least 1% by weight, more preferably at least 5% by weight, particularly preferably in the range from 10 to 97% by weight.

The content of vinylphosphonic acid monomers in compositions used for grafting is preferably at least 3% by weight, more preferably at least 5% by weight, particularly preferably in the range from 10 to 99% by weight.

The mixture comprising vinylphosphonic acid/vinylsulfonic acid produced in step B) and the composition used for grafting can be a solution and may further comprise dispersed or suspended constituents.

The polymerization of the vinyl-containing phosphonic/sulfonic acid monomers in step C) is carried out at temperatures above room temperature (20° C.) and less than 200° C., preferably at temperatures in the range from 40° C. to 150° C., in particular from 50° C. to 120° C. The polymerization is preferably carried out under atmospheric pressure, but can also be carried out under superatmospheric pressure. The polymerization is preferably carried out under inert gas such as nitrogen.

The polymerization leads to an increase in the volume and the weight. The degree of grafting, characterized by the weight increase during grafting, is at least 10%, preferably greater than 20% and very particularly preferably greater than 50%.

The degree of grafting is calculated from the mass of the dry film prior to grafting, m₀, and the mass of the dried film after grafting and washing (in step D), m₁, according to
degree of grafting=(m₁−m₀)/m₀*100

After the above steps have been gone through once, they can be repeated a number of times in the order described. The number of repetitions depends on the desired degree of grafting.

The polymer obtained in step C) comprises from 0.5 to 96% by weight of the organic polymer and from 99.5 to 4% by weight of polyvinylphosphonic acid and/or polyvinylsulfonic acid. The polymer obtained in step. C) preferably comprises from 3 to 90% by weight of the organic polymer and from 97 to 10% by weight of polyvinylphosphonic acid and/or polyvinylsulfonic acid.

The casting (step D) of a sheet-like structure, in particular a polymer film, from a polymer solution comprising polymers obtained according to step C) is carried out by means of measures known per se from the prior art. For example, the mixture obtained according to step C) can be used for casting. Furthermore, the grafted polymer obtained can firstly be isolated from the mixture from step C), after which the isolated polymer is dissolved in a solvent, of which examples have been given above, and subsequently cast to produce a film.

After casting according to step D), monomer residues present in the sheet-like structure can be polymerized thermally, photochemically, chemically and/or electrochemically. Depending on the proportion of solvent residues, drying according to step E) is achieved thereby, leading to a self-supporting membrane.

The polymerization can be effected, for example, by action of IR or NIR (IR=infrared, i.e. light having a wavelength of more than 700 nm; NIR=near IR, i.e. light having a wavelength in the range from about 700 to 2000 nm or an energy in the range from about 0.6 to 1.75 eV).

The polymerization can be effected, for example, by action of UV light having a wavelength of less than 400 nm. This polymerization method is known per se and is described, for example, in Hans Joerg Elias, Makromolekulare Chemie, 5th edition, volume 1, pp. 492-511; D. R. Arnold, N. C. Baird, J. R. Bolton, J. C. D. Brand, P. W. M. Jacobs, P. de Mayo, W. R. Ware, Photochemistry—An Introduction, Academic Press, New York and M. K. Mishra, Radical Photopolymerization of Vinyl Monomers, J. Macromol. Sci.—Revs. Macromol. Chem. Phys. C22 (1982-1983) 409.

The polymerization can, for example, be achieved by action of β-rays, γ-rays and/or electron beams. In a particular embodiment of the present invention, a membrane is irradiated with a radiation dose in the range from 1 to 300 kGy, preferably from 3 to 200 kGy and very particularly preferably from 20 to 100 kGy.

The optional polymerization of the vinyl-containing sulfonic acid and/or vinyl-containing phosphonic acid monomers is preferably carried out at temperatures above room temperature (20° C.) and less than 200° C., in particular at temperatures in the range from 40° C. to 150° C., particularly preferably from 50° C. to 120° C. The polymerization is preferably carried out under atmospheric pressure, but can also be carried out under superatmospheric pressure. The polymerization leads to a strengthening of the sheet-like structure, and this strengthening can be monitored by microhardness measurement. The increase in hardness resulting from the polymerization is preferably at least 20%, based on the hardness of the sheet-like structure obtained in step B).

In a particular embodiment of the present invention, the membranes have a high mechanical stability. This parameter is given by the hardness of the membrane which is determined by means of microhardness measurement in accordance with DIN 50539. For this purpose, the membrane is gradually loaded with a Vickers diamond to a force of 3 mN over a period of 20 s and the indentation depth is determined. According to this, the hardness at room temperature is at least 0.01 N/mm², preferably at least 0.1 N/mm² and very particularly preferably at least 1 N/mm², without a restriction being implied thereby. The force is subsequently kept constant at 3 mN for 5 s and the creep is calculated from the indentation depth. In the case of preferred membranes, the creep C_{HU} 0.003/20/5 under these conditions is less than 20%, preferably less than 10% and very particularly preferably less than 5%. The modulus YHU determined by means of microhardness measurement is at least 0.5 MPa, in particular at least 5 MPa and very particularly preferably at least 10 MPa, without a restriction being implied thereby.

Depending on the type of composition used for grafting and on any polymerization/crosslinking of the surface, drying can be advantageous. Drying of the sheet-like structure in step E) can be carried out at temperatures ranging from room temperature to 300° C. Drying is carried out under atmospheric pressure or under reduced pressure. The drying time is dependent on the thickness of the film and is from 10 seconds to 24 hours. If the sheet-like structure formed in step D) is a film, this is dried according to step E) and is subsequently self-supporting, so that it can be detached from the support without damage and, if appropriate, be processed further. Drying is carried out by means of drying methods customary in the films industry.

Solvents, for example, can be very largely removed by means of the drying carried out in step E). Thus, the residual content of organic solvents is usually less than 30% by weight, preferably less than 20% by weight, particularly preferably less than 10% by weight.

A further decrease in the residual solvent content to below 2% by weight can be achieved by increasing the drying temperature and drying time. In one variant, drying can also be combined with a washing step. A particularly gentle process for after-treatment and removal of the residual solvent is disclosed in the German patent application 10109829.4.

In a particular embodiment of the present invention, the membrane comprises at least 3% by weight, preferably at least 5% by weight and particularly preferably at least 7% by weight, of phosphorus (as element), based on the total weight of the membrane. The proportion of phosphorus can be determined by elemental analysis. For this purpose, the membrane is dried at 110° C. for 3 hours under reduced pressure (1 mbar). In a particular embodiment of the present invention, the membrane comprises at least 3% by weight, preferably at least 5% by weight and particularly preferably at least 7% by weight, of phosphorus (as element), based on the total weight of the membrane. The proportion of phosphorus can be determined by elemental analysis. For this purpose, the membrane is dried at 110° C. for 3 hours under reduced pressure (1 mbar). This proportion is particularly preferably determined after the optional washing step.

The polymer membrane of the invention has improved materials properties compared to the previously known acid-doped polymer membranes. In particular, it displays, in contrast with known undoped polymer membranes, an intrinsic conductivity at temperatures above 100° C. and without moistening. This is due, in particular, to a polymeric polyvinylphosphonic acid and/or polyvinylsulfonic acid bound covalently to the polymer framework.

The intrinsic conductivity of the membrane of the invention at temperatures of 80° C., if appropriate with moistening, is generally at least 0.1 mS/cm, preferably at least 1 mS/cm, in particular at least 2 mS/cm and particularly preferably at least 5 mS/cm.

At a proportion by weight of polyvinylphosphonic acid of greater than 10%, based on the total weight of the membrane, the membranes generally display a conductivity at a temperature of 160° C. of at least 1 mS/cm, preferably at least 3 mS/cm, in particular at least 5 mS/cm and particularly preferably at least 10 mS/cm. These values are achieved without moistening.

The specific conductivity is measured by means of impedance spectroscopy in a four-pole arrangement in the potentiostatic mode using platinum electrodes (wire, 0.25 mm diameter). The distance between the current-collecting electrodes is 2 cm. The spectrum obtained is evaluated using a simple model consisting of a parallel arrangement of an ohmic resistance and a capacitor. The specimen cross section of the membrane doped with phosphoric acid is measured immediately before mounting of the specimen. To measure the temperature dependence, the measurement cell is brought to the desired temperature in an oven and the temperature is regulated by means of a Pt-100 resistance thermometer positioned in the immediate vicinity of the specimen. After the temperature has been reached, the specimen is maintained at this temperature for 10 minutes before commencement of the measurement.

The crossover current density in operation using 0.5 M methanol solution at 90° C. in a liquid direct methanol fuel cell is preferably less than 100 mA/cm², in particular less than 70 mA/cm², particularly preferably less than 50 mA/cm² and very particularly preferably less than 10 mA/cm². The crossover current density in operation using a 2 M methanol solution at 160° C. in a gaseous direct methanol fuel cell is preferably less than 100 mA/cm², in particular less than 50 mA/cm², very particularly preferably less than 10 mA/cm².

To determine the crossover current density, the amount of carbon dioxide liberated at the cathode is measured by means of a CO₂ sensor. The crossover current density is calculated from the resulting value of the amount of CO₂, in the manner described by P. Zelenay, S. C. Thomas, S. Gottesfeld in S. Gottesfeld, T. F. Fuller “Proton Conducting Membrane Fuel Cells II” ECS Proc. Vol. 98-27, pp. 300-308.

Subsequent to the treatment according to step E), the sheet-like structure can be additionally crosslinked on the surface by the action of heat in the presence of atmospheric oxygen. This hardening of the membrane surface achieves an additional improvement in the properties of the membrane.

Crosslinking can also be effected by action of IR or NIR (IR=infrared, i.e. light having a wavelength of more than 700 nm; NIR=near IR, i.e. light having a wavelength in the range from about 700 to 2000 nm or an energy in the range from about 0.6 to 1.75 eV). A further method is irradiation with β-rays. The radiation dose is in the range from 5 to 200 kGy.

In a further step, the grafted membrane produced according to the invention can be freed of unreacted constituents by washing with water or alcohols such as methanol, 1-propanol, isopropanol or butanol or mixtures thereof. Washing takes place at temperatures from room temperature (20° C.) to 100° C., in particular at from room temperature to 80° C. and very particularly preferably at from room temperature to 60° C.

To achieve a further improvement in the use properties, fillers, in particular proton-conducting fillers, and additional acids can also be added to the membrane. The addition can be carried out either in step A or after the polymerization.

Nonlimiting examples of proton-conducting fillers are
sulfates such as CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
phosphates such as Zr(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
polyacids such as H₃PW₁₂O₄₀.nH₂O (n=21-29), H₃SiW₁₂O₄₀.nH₂O (n=21-29), HₓWO₃, HSbWO₆, H₃PMo₁₂O₄₀, H₂Sb₄O₁₁, HTaWO₆, HNbO₃, HTiNbO₅, HTiTaO₂, HSbTeO₆, H₅Ti₄O₉, HSbO₃, H₂MoO₄,
selenides and arsenides such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
oxides such as Al₃O₃, Sb₂O₅, ThO₂, SnO₂, ZrO₂, MoO₃,
silicates such as zeolites, zeolites (NH₄⁺), sheet silicates, framework silicates, H-natrolites, H-mordenites, NH₄-analcines, NH₄-sodalites, NH₄-gallates, H-montmorillonites,
acids such as HClO₄, SbF₅,
fillers such as carbides, in particular SiC, Si₃N₄, fibers, in particular glass fibers, glass powders and/or polymer fibers, preferably ones based on polyazoles.

These additives can be present in customary amounts in the proton-conducting polymer membrane, but the positive properties such as high conductivity, long life and high mechanical stability of the membrane should not be impaired too much by addition of excessive amounts. In general, the membrane after the polymerization in step C) contains not more than 80% by weight, preferably not more than 50% by weight and particularly preferably not more than 20% by weight, of additives.

In addition, this membrane can further comprise perfluorinated sulfonic acid additives (0.1-20% by weight, preferably 0.2-15% by weight, very particularly preferably 0.2-10% by weight). These additives lead to an increase in power, in the vicinity of the cathode to an increase in the oxygen solubility and oxygen diffusion and to a reduction in the adsorption of phosphoric acid and phosphate onto platinum. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902, and Perfluorosulfonimides as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90.)

Nonlimiting examples of persulfonated additives are:
trifluoromethanesulfonic acid, potassium trifluoromethanesulfonate, sodium trifluoromethanesulfonate, lithium trifluoromethanesulfonate, ammonium trifluoromethanesulfonate, potassium perfluorohexanesulfonate, sodium perfluorohexanesulfonate, lithium perfluorohexanesulfonate, ammonium perfluorohexanesulfonate, perfluorohexanesulfonic acid, potassium nonafluorobutanesulfonate, sodium nonafluorobutanesulfonate, lithium nonafluorobutanesulfonate, ammonium nonafluorobutanesulfonate, cesium nonafluorobutanesulfonate, triethylammonium perfluorohexanesulfonate, perfluorosulfonimides and nafion.

Furthermore, the membrane can further comprise additives which scavenge (primary antioxidants) or destroy (secondary antioxidants) the free peroxide radicals produced in the reduction of oxygen and thereby improve the life and stability of the membrane and membrane-electrode unit as described in JP2001118591 A2. The mode of action and molecular structures of such additives are described in F. Gugumus in Plastics Additives, Hanser Verlag, 1990; N. S. Allen, M. Edge Fundamentals of Polymer Degradation and Stability, Elsevier, 1992; or H. Zweifel, Stabilization of Polymeric Materials, Springer, 1998.

Nonlimiting examples of such additives are:
bis(trifluoromethyl)nitroxide, 2,2-diphenyl-1-picrinylhydrazyl, phenols, alkylphenols, sterically hindered alkylphenols such as Irganox, in particular Irganox 1135 (Ciba Geigy), aromatic amines, sterically hindered amines such as Chimassorb; sterically hindered hydroxylamines, sterically hindered alkylamines, sterically hindered hydroxylamines, sterically hindered hydroxyamine ethers, phosphites such as Irgafos, nitrosobenzene, methyl-2-nitrosopropane, benzophenone, benzaldehyde tert-butyl nitrone, cysteamine, melanines, lead oxides, manganese oxides, nickel oxides and cobalt oxides.

In a further variant of the invention, the polymerization according to step C) can occur after formation of the sheet-like structure according to step D). In this case, the polymerization is carried out in the thin layer.

Possible fields of use of the polymer membranes of the invention include, inter alia, use in fuel cells, in electrolysis, in capacitors and in battery systems. Owing to their property profile, the polymer membranes are preferably used in fuel cells, very particularly preferably in direct methanol fuel cells.

The present invention further provides the polymer solutions obtainable according to step C). These represent valuable intermediates. In addition, the solutions can also be used for coating electrodes or, after removal of the solvents, as ionomers.

The present invention likewise provides a polymer obtainable by separating off or evaporating the solvent from step C). Such polymers and solutions can also be used as ionomers for coating electrodes or for filling porous polymer substrates, for example expanded Teflon.

In a further process variant, such a polymer after the solvent has been separated off or evaporated after step C) can also be processed by means of classical methods of thermoplastic shaping, e.g. injection molding or extrusion, to give proton-conducting membranes.

The abovementioned auxiliaries and fillers can also be present in this process variant.

The present invention also provides a membrane-electrode unit which comprises at least one polymer membrane according to the invention. The membrane-electrode unit displays a high performance even at a low content of catalytically active substances, such as platinum, ruthenium or palladium. Gas diffusion layers provided with a catalytically active layer can be used for this purpose.

The gas diffusion layer generally displays electron conductivity. Sheet-like, electrically conductive and acid-resistant structures are usually used for this purpose. These include, for example, carbon fiber papers, graphitized carbon fiber papers, woven carbon fiber fabrics, graphitized woven carbon fiber fabrics and/or sheet-like structures which have been made conductive by addition of carbon black.

The catalytically active layer comprises a catalytically active substance. Such substances include, inter alia, noble metals, in particular platinum, palladium, rhodium, iridium and/or ruthenium. These substances can also be used in the form of alloys with one another. Furthermore, these substances can also be used in alloys with base metals such as Cr, Zr, Ni, Co and/or Ti. In addition, the oxides of the abovementioned noble metals and/or base metals can also be used.

According to a particular aspect of the present invention, the catalytically active compounds are used in the form of particles which preferably have a size in the range from 1 to 1000 nm, in particular from 10 to 200 nm and particularly preferably from 20 to 100 nm.

Furthermore, the catalytically active layer can further comprise customary additives. Such additives include, inter alia, fluoropolymers such as polytetrafluoroethylene (PTFE) and surface-active substances.

In a particular embodiment of the present invention, the weight ratio of fluoropolymer to catalyst material comprising at least one noble metal and, if appropriate, one or more support materials is greater than 0.1, preferably in the range from 0.2 to 0.6.

In a particular embodiment of the present invention, the catalyst layer has a thickness in the range from 1 to 1000 μm, in particular from 5 to 500 μm, preferably from 10 to 300 μm. This value represents a mean which can be determined by measuring the layer thickness in cross-sectional micrographs which can be obtained using a scanning electron microscope (SEM).

In a particular embodiment of the present invention, the noble metal content of the catalyst layer is from 0.1 to 10.0 mg/cm², preferably from 0.3 to 6.0 mg/cm² and particularly preferably from 0.2 to 3.0 mg/cm². These values can be determined by elemental analysis of a sheet-like sample.

For further information on membrane-electrode units, reference may be made to the specialist literature, in particular the patent applications WO 01/18894 A2, DE 195 09 748, DE 195 09 749, WO 00/26982, WO 92/15121 and DE 197 57 492. The disclosure of the abovementioned references in respect of the structure and the production of membrane-electrode units and also the electrodes, gas diffusion layers and catalysts to be selected is incorporated by reference into the present description.

In a further variant, a catalytically active layer can be applied to the membrane of the invention and be joined to a gas diffusion layer.

The present invention likewise provides a membrane-electrode unit which comprises at least one polymer membrane according to the invention, if appropriate in combination with a further polymer membrane based on polyazoles or a polymer blend membrane.

1-15. (canceled)

16. A proton-conducting electrolyte membrane obtained by a process comprising the steps of:
a) irradiating a polymer with radiation to generate free radicals;
b) preparing a mixture of the polymer irradiated in step a) with monomers that include vinylphosphonic acid or monomers that include vinylsulfonic acid;
c) polymerizing the monomers comprising vinylphosphonic acid or vinylsulfonic acid;
d) casting a sheet-like structure that includes the polymers obtained according to step c); and
e) drying the sheet-like structure to form a self-supporting membrane.

17. The membrane of claim 16, characterized in that the mixture in step b) is prepared with addition of a solvent or solvent mixture.

18. The membrane of claim 16, characterized in that the polymer used in step a) is a polymer containing at least one fluorine, nitrogen, oxygen, or sulfur atom in a repeating unit or in different repeating units.

19. The membrane of claim 16, characterized in that the vinyl-containing phosphonic acid monomer used in step b) is a compound of the formula 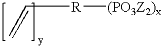
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 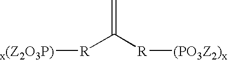
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 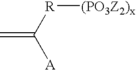
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10.

20. The membrane of claim 16, characterized in that the vinyl-containing sulfonic acid monomer used in step b) is a compound of the formula 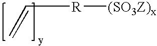
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 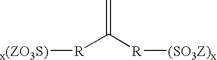
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 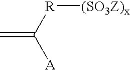
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10.

21. The membrane of claim 16, characterized in that the mixture further includes additional monomers capable of crosslinking.

22. The membrane of claim 16, characterized in that the polymerization according to step c) is carried out after formation of the sheet-like structure according to step d).

23. The membrane of claim 16, characterized in that the membrane has an intrinsic conductivity of at least 0.001 S/cm.

24. A proton-conducting membrane comprising:
from 0.5 to 94% by weight of a polymer containing at least one fluorine, nitrogen, oxygen, or sulfur atom in a repeating unit or in different repeating units, and which is a film or layer; and
from 4% to 99.5% by weight of a polyvinylphosphonic acid and polyvinylsulfonic acid, wherein the polyvinylphosphonic acid is obtained by polymerizing a vinyl-containing phosphonic acid monomer of the formula 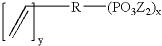
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 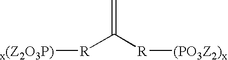
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 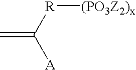
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10; and
wherein the polyvinylsulfonic acid is obtained from polymerizing a vinyl-containing sulfonic acid monomer of the formula 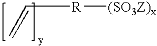
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 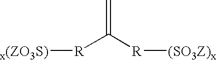
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 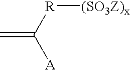
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10.

25. A proton-conducting polymer blend obtained by a process comprising the steps of:
a) irradiating a polymer with electromagnetic radiation to generate free radicals;
b) preparing a mixture of the polymer which has been irradiated in step a) with monomers that include vinylphosphonic acid or monomers that include vinylsulfonic acid; and
c) polymerizing the monomers comprising vinylphosphonic acid or vinylsulfonic acid.

26. The blend of claim 25, characterized in that the mixture in step b) is prepared with addition of a solvent or solvent mixture.

27. The blend of claim 25, characterized in that the polymer used in step a) is a polymer containing at least one fluorine, nitrogen, oxygen, or sulfur atom in a repeating unit or in different repeating units.

28. The blend of claim 25, characterized in that the vinyl-containing monomer used in step b) includes a vinyl-containing phosphonic acid monomer of the formula 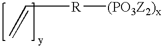
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 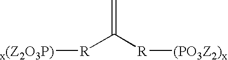
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 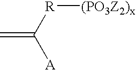
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
a vinyl-containing sulfonic acid monomer of the formula 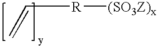
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 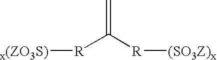
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 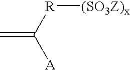
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10.

29. A membrane-electrode unit comprising:
at least one electrode, and
at least one proton-conducting electrolyte membrane obtained by a process comprising the steps of:
a) irradiating a polymer with radiation to generate free radicals;
b) preparing a mixture of the polymer irradiated in step a) with monomers that include vinylphosphonic acid or monomers that include vinylsulfonic acid;
c) polymerizing the monomers comprising vinylphosphonic acid or vinylsulfonic acid;
d) casting a sheet-like structure that includes the polymers obtained according to step c); and
e) drying the sheet-like structure to form a self-supporting membrane.

30. The unit of claim 29, characterized in that the membrane has an intrinsic conductivity of at least 0.001 S/cm.

31. The unit of claim 29, characterized in that the membrane includes
from 0.5 to 94% by weight of a polymer containing at least one fluorine, nitrogen, oxygen, or sulfur atom in a repeating unit or in different repeating units, and which is a film or layer; and
from 4% to 99.5% by weight of a polyvinylphosphonic acid and polyvinylsulfonic acid, wherein the polyvinylphosphonic acid is obtained by polymerizing a vinyl-containing phosphonic acid monomer of the formula 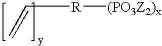
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 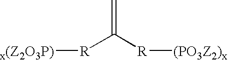
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 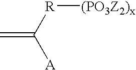
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10; and
wherein the polyvinylsulfonic acid is obtained from polymerizing a vinyl-containing sulfonic acid monomer of the formula 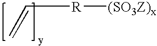
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN,
x is 1, 2, 3, 4, 5, 6, 7, 8, 9, or 10, and
y is 1, 2, 3, 4, 5, 6, 7, 8, 9, or 10, or
the formula 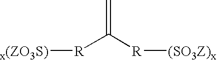
where
R is a bond, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
Z are each, independently of one another, hydrogen, a C1-C15 alkyl group, C1 —C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10, or
the formula 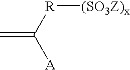
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, or NZ₂,
R is a bond, a divalent C1-C15 alkylene group, a divalent C1-C15 alkylenoxy group, or a divalent C5-C20 aryl or heteroaryl group, with the above radicals optionally substituted by halogen, —OH, COOZ, —CN, or NZ₂,
Z are each, independently of one another, hydrogen, a C1-C15 alkyl group, C1-C15 alkoxy group, ethylenoxy group, or C5-C20 aryl or heteroaryl group, with the above radicals optionally substituted by halogen, —OH, or —CN, and
x is 1, 2, 3, 4, 5, 6, 7, 8, 9, or 10.

32. A membrane-electrode unit comprising
at least one electrode and
a proton-conducting polymer blend obtained by a process comprising the steps of:
a) irradiating a polymer with electromagnetic radiation to generate free radicals;
b) preparing a mixture of the polymer which has been irradiated in step a) with monomers that include vinylphosphonic acid or monomers that include vinylsulfonic acid; and
c) polymerizing the monomers comprising vinylphosphonic acid or vinylsulfonic acid.

33. A fuel cell comprising one or more proton-conducting electrolyte membranes obtained by a process that includes the steps of:
a) irradiating a polymer with radiation to generate free radicals;
b) preparing a mixture of the polymer irradiated in step a) with monomers that include vinylphosphonic acid or monomers that include vinylsulfonic acid;
c) polymerizing the monomers comprising vinylphosphonic acid or vinylsulfonic acid;
d) casting a sheet-like structure that includes the polymers obtained according to step c); and
e) drying the sheet-like structure to form a self-supporting membrane.

34. A fuel cell comprising a proton-conducting polymer blend obtained by a process comprising the steps of:
a) irradiating a polymer with electromagnetic radiation to generate free radicals;
b) preparing a mixture of the polymer which has been irradiated in step a) with monomers that include vinylphosphonic acid or monomers that include vinylsulfonic acid;
c) polymerizing the monomers comprising vinylphosphonic acid or vinylsulfonic acid.
